(19) United States
(12) Patent Application Publication
(10) Pub. No.: US 2026/0065469 A1
(43) Pub. Date: Mar. 5, 2026

(54) METHOD FOR IMPROVED POLYPS DETECTION

(71) Applicants: SORBONNE UNIVERSITE, PARIS (FR); CENTRE NATIONAL DE LA RECHERCHE SCIENTIFIQUE, PARIS (FR); ASSISTANCE PUBLIQUE-HÔPITAUX DE PARIS, PARIS (FR)

(72) Inventors: Bertrand GRANADO, Paris Cedex 05 (FR); Andrea PINNA, Paris Cedex 05 (FR); Xavier DRAY, Paris Cedex 05 (FR); Orlando CHUQUIMIA, Paris Cedex 05 (FR)

(21) Appl. No.: 19/101,035

(22) PCT Filed: Aug. 4, 2022
(86) PCT No.: PCT/IB2022/000439

§ 371 Date: Feb. 4, 2025

(51) Int. Cl. G06T 7/00; G06V 10/25; G06V 10/764; G06V 20/40

(52) U.S. Cl. CPC G06T 7/0012; G06V 10/25; G06V 10/764; G06V 20/46; G06V 2201/032

(57) ABSTRACT

The disclosure relates to a method for detecting polyps from a video sequence comprising a plurality of images. The method includes, after an extraction of regions of interests likely to contain a polyp within the different images, a description of said regions and a classification of said regions as likely to contain a polyp or not. The method includes a first aggregation of same regions of interest on said images consisting of maintaining as a region of interest belonging to the first class on a given image, a region of interest classified in the first class for each successive image; and then a second aggregation of images consisting of maintaining as a region of interest on any image comprised between first and second images, the region of interest appearing for the first time on said first image and for the last time on said second image.

### CROSS-REFERENCE TO RELATED APPLICATION(S)

This present application is a national stage application of International Patent Application No. PCT/IB2022/000439, filed Aug. 4, 2022, the disclosures of which is hereby incorporated by reference in its entirety.

### TECHNICAL FIELD

The present disclosure concerns a field of the detection of polyps. It is of particular importance to detect, for example, a colorectal cancer. A method for detecting polyps from a video sequence is also disclosed.

### BACKGROUND

Amongst the techniques to detect the presence of polyps, the automatic detection of polyps, based on video sequences and specific data processing techniques of the video sequence, is widely used.

Such a technique is for example disclosed in Chuquimia & al., “Polyp follow-up in an Intelligent Wireless Capsule Endoscopy”, In 2019 IEEE Biomedical Circuits and System Conference (BioCAS) (October 2019), pp. 1-4, ISSN: 2163-4025.

The method proposed in this paper allows achieving high polyp detection performance. This performance is evaluated by two well-known parameters, namely the sensitivity and the specificity which respectively characterize the capacity of the method to avoid, in the detection, the “false negatives” and the “false positives”.

However, there is a need to further improve the performance of such methods, namely to increase the detection rate of polyps.

### SUMMARY

An aim of the disclosure is to improve the performance, namely the detection rate, of the methods for detecting polyps from a video sequence.

To reach this aims; it is proposed a method for detecting polyps from a video sequence comprising a plurality of images, said method comprising the following steps:
a) an extraction of regions of interest likely to contain a polyp, said extraction consisting of determining circular or elliptical shapes within said images;
b) a description of said regions of interest with at least one predefined descriptor, advantageously with at least one texture descriptor and at least one luminance descriptor;
c) a classification of said regions of interest according to the following rules:
   if said region of interest is considered as containing a polyp by means of said at least one descriptor, it is classified in a first class, and
   if said region of interest is considered as not containing any polyp, by means of said at least one descriptor, it is classified in a second class;
d) a follow-up, by a motion estimation technique, of any region of interest belonging to the first class from a given image and on successive images following said given image; and
e) for each of said successive images, a repetition of step b) and of step c) for said regions of interests that are subject of the follow-up;
characterized in that said method further comprises the following steps:
f) an aggregation of same regions of interest on said images called first aggregation, said first aggregation consisting of maintaining as a region of interest belonging to the first class on a given image, a region of interest also classified in the first class for each successive images; then:
g) an aggregation of images called second aggregation, said second aggregation consisting of maintaining as a region of interest on any image comprised between a first image and a second image, a region of interest appearing for the first time on said first image and for the last time on said second image.

The method according to the disclosure may comprise the following features, taken alone or in combination:
In the method according to the present disclosure the step a) comprises, for any image in color, the following sub-steps:
a₀) converting said given image in shades of grey;
a₁) noise filtering the image, for example with a 3*3 median filter;
a₂) identifying shapes in the image, for example with a Canny filter;
a₃) identifying circular or elliptic shapes among the shapes previously identified within said image; and
a₄) extracting a region of interest (ROI) from any region of said image whereby a circular or elliptical shapes has been identified.

In said method several predefined descriptors are chosen for step b) among which descriptors related to both the texture and the luminosity.

In said method the step c) is based on at least one fuzzy tree comprising at least one attribute and a plurality of classes, said at least one attribute corresponding to said at least one descriptor and said plurality of classes comprising the first class and the second classes.

Said at least one fuzzy tree is a fuzzy tree is constructed by means of a learning phase comprising the following steps:
LP1) constructing said at least one fuzzy tree with a public database, for example the ASU-Mayo database;
LP2) constructing a learning database of the regions of interests from the regions of interest automatically extracted from the classification of step c);
LP3) testing said classification on said public database;
LP4) putting into the learning database of the regions of interest constructed at step LP2), the regions of interest that have not been correctly classified during the test carried out at step LP3);
LP5), repeating steps LP3) and LP4), for example for a predefined number of iterations.

In said method according step c) is further based on at least one fuzzy forest comprising a plurality of fuzzy trees according to the preceding claim and whose outputs, namely the classification according to either the first class or the second class, are subject to a conorm calculation in order to obtain a global classification according to either the first class or the second class.

In said method step d) is carried out by a block corresponding method comprising the following sub-steps:
d₁) associating a region of interest belonging to the first class in said given image with a block of P*Q pixels*pixels, where P, Q are natural integers;
d₂) displacing said block B_{p,q} according to several candidate movement vectors;
d₃) carrying out, for each candidate movement vector, a comparison between a value of intensity associated with the block in said given image and the same value of intensity associated with the displaced block;
d₄) determining the candidate movement vector for which the comparison reaches a minimum value; said candidate movement vector being therefore the movement vector with which the bloc B_{p,q} has to be displaced; and
d₅) displacing the block from said given image to said successive images with according to said movement vector.

In said method step e) as well as step f) are carried out with a temporal depth equal or greater than 3 images.

In said method step g) is carried out with a temporal depth equal or greater than 10 images.

Another object of the present disclosure is related to a device comprising:
a means for acquiring a video sequence, and
a processor or a plurality of processors to carry out, from said video sequence, the method to the disclosure described above.

Said device according to the may be an endoscopic capsule.

In an alternative said device may be affixed or integrated in an endoscope, for example the endoscope proposed in US 2022/0094901 A1.

### BRIEF DESCRIPTION OF THE FIGURES

The disclosure will be better understood with the help of the description that follows only provided as an example and carried out by reference to the annexed drawings in which:

FIG. 1 is a general scheme of a method according to the disclosure;

FIG. 2 shows the operating principle of a fuzzy tree that may be used for a step of classification of the method according to the disclosure;

FIG. 3 shows the operating principle of a fuzzy forest that may also be used for a step of classification of the method according to the disclosure;

FIG. 4 shows, on a same video sequence, the effect of several successive steps of the method of the disclosure on the polyp detection; and

FIG. 5 shows, on a same video sequence but different from the video sequence of FIG. 2, the effect of final steps of the method of the disclosure.

### DETAILED DESCRIPTION

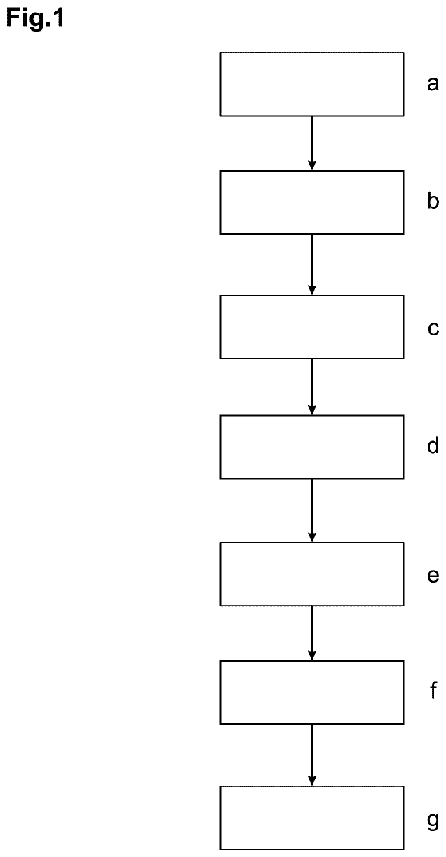

FIG. 1 is an overview scheme of the method according to the present disclosure.

In FIG. 1, we can see the different steps of the method of the disclosure leading to the detection of polyps (output) from the images of the video sequence (input). As can be seen from this figure, the analysis is both spatial and temporal.

The method more specifically comprises the following steps:
a) an extraction of regions of interest (ROI) likely to contain a polyp, said extraction consisting of determining circular or elliptical shapes within said images;
b) a description of said regions of interest with at least one predefined descriptor, advantageously with at least one texture descriptor and at least one luminance descriptor;
c) a classification of said regions of interest according to the following rules:
if said region of interest is considered as containing a polyp by means of said at least one descriptor, it is classified in a first class,
if said region of interest is considered as not containing any polyp, by means of said at least one descriptor, it is classified in a second class;
d) a follow-up, by a motion estimation technique, of any region of interest belonging to the first class from a given image and on successive images following said given image;
e) for each of said successive images, a repetition of step b) and of step c) for said regions of interests that are subject of the follow-up;
f) an aggregation of same regions of interest on said images called first aggregation, said first aggregation consisting of maintaining as a region of interest belonging to the first class on a given image, a region of interest also classified in the first class for each successive images; then:
g) an aggregation of images called second aggregation, said second aggregation consisting of maintaining as a region of interest on any image comprised between a first image and a second image, a region of interest appearing for the first time on said first image and for the last time on said second image.

Steps a) to c) and step e) are related to a spatial analysis while steps d), f) and g) are related to a temporal analysis

There are several ways to implement step a).

As an example, we may however proceed as follows for an image in color:
a₀) converting said given image in shades of grey (Y), for example in the RGB (Red-Green-Blue) color space by the following formulae (R1):

$$Y = 16 + \frac{66}{256} R + \frac{129}{256} G + \frac{25}{256} B \qquad ( R1 )$$

a₁) noise filtering the image, for example with a median filter, typically of size 3*3;
a₂) identifying shapes in the image, for example with a Canny filter (Canny J., A Computational Approach to Edge Detection, IEEE Trans. Pattern Anal. Mach. Intell. PAMI-8, vol. 6 (November 1986), pp. 679-698).
a₃) identifying circular or elliptic shapes among the shapes previously identified within said image, for example with a Hough transform of the image;
a₄) extracting a region of interest (ROI) from any region of said image whereby a circular or elliptical shapes has been identified.

The conversion of an image in color into shades of grey allows reducing the number of calculations, as only one piece of information Y is therefore used instead of three (R, G, B) for the image in color. In addition, this type of conversion has the advantage of maintaining the information concerning the texture of the image, useful to correctly detect shapes within the image.

At step b), the description of each region of interest (ROI) is advantageously carried out with at least one texture descriptor and at least one luminance descriptor. These descriptors are indeed discriminants to identify polyps.

For the luminance, we may use at least one descriptor chosen among: the mean value, the variance, the skewness, the kurtosis or a combination thereof. These descriptors are provided in the ANNEX to this description.

For the texture, we may use the descriptors proposed by Haralick & al., Textural Features for Image Classification, IEEE Trans. Yst. Man Cybern. SMC-3, vol. 6 (November 1973), pp. 610-621. These texture descriptors are determined from the calculation of co-occurrence matrices, a co-occurrence matrix measuring the probability that a couple of levels of grey, verifying a given spatial law, appears in the image. Indeed, the level of grey of a pixel of the image strongly depends on the level of grey of the neighboring pixels. This method is a statistical method for characterizing the periodicity and the directivity of the texture in an image.

For a given image I, of W*H pixels, the matrix co-occurrence matrix for the horizontal direction (0°) of the image is calculated as follows:

Algorithm 1

| | |
|---|---|
| 1: | M(0 : 255, 0 : 255) = 0 |
| 2: | for each column i from d to W − d do |
| 3: | for each row j from d to H − d do |
| 4: | M(I_{(i,j)}, I_{(i,j+d)}) = M(I_{(i,j)}, I_{(i,j+d)}) + 1 |
| 5: | M(I_{(i,j)}, I_{(i,j-d)}) = M(I_{(i,j)}, I_{(i,j-d)}) + 1 |
| 6: | end for |
| 7: | end for |

Once the co-occurrence matrices M(I,j) are determined, several descriptors can be derived. Several texture descriptors, particularly relevant to detect polyps are provided in the ANNEX.

At step c), there are different ways to proceed in order to classify the regions of interest (ROI) into the first class (binary value “1”: presence of a polyp) or into the second class (binary value “0”: absence of a polyp), from the descriptors.

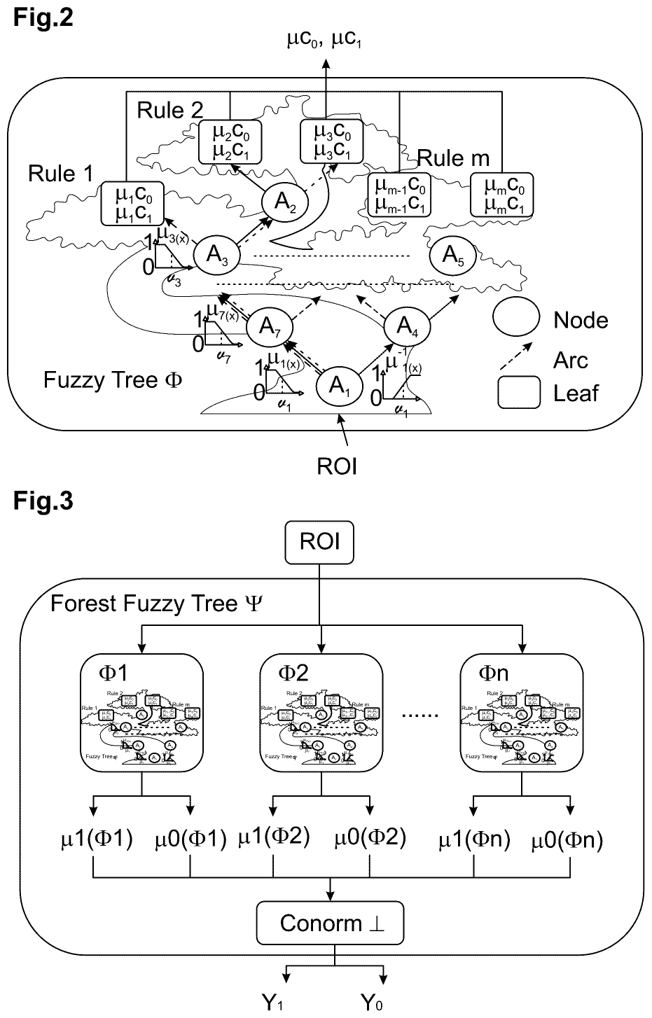

One of them is to use a fuzzy tree, as represented in FIG. 2. From a general viewpoint, a fuzzy tree classifier allows managing imprecise data, such as those provided by the descriptors, and as a consequence the detection robustness. It is an inductive recognition algorithm consisting of two parts: i) a learning phase and ii) a classification phase.

The classification phase can be explained by relying on FIG. 2. To use a fuzzy tree Φ to classify a region of interest ROI represented by the parameter ξᵢ(w₁, w₂, . . . , w_{D}), where] w₁, w₂, . . . , w_{D} are the D descriptors chosen to describe said region of interest ROI at step b), we may use the method of generalized Modus Ponem.

In this method, we first calculate a similarity degree Deg(wₘ₍ⱼ₎,vₘ₍ⱼ₎) between the observed value wₘ₍ⱼ₎ and the break point vₘ₍ⱼ₎ of each attribute j of the rule m using a triangular norm T. As a triangular norm T, we may for instance use the triangular norm equal to the minimum between μⱼ(wₘ₍ⱼ₎ and μⱼ(vₘ₍ⱼ₎) We have, for 1≤j≤J.

$$Deg ( {w}_{m ( j )} , {v}_{m ( j )} ) = \frac{⊤ ( {w}_{m ( j )} , {v}_{m ( j )} )}{{μ}_{j} ( {w}_{m ( j )} )} \qquad ( R2 )$$

Then, we calculate a satisfiability degree Fded_{m(c}_{ₖ}₎ with k=0 (no polyp) or 1 (polyp) using all the similarity degrees Deg(wₘ₍ⱼ₎,vₘ₍ⱼ₎) of the J attributes of the rule m. For instance, as a triangular norm T, we may use the triangular norm T equal to the multiplication between all the degrees Deg(wₘ₍ⱼ₎,vₘ₍ⱼ₎), namely:

$${Fded}_{m ( c 1 )} = {⊤}_{j = 1 , … , J} Deg ( {w}_{m ( j )} , {v}_{m ( j )} ) * {μ}_{m , c 1} \qquad ( R3 )$$

$${Fded}_{m ( c 0 )} = {⊤}_{j = 1 , … , J} Deg ( {w}_{m ( j )} , {v}_{m ( j )} ) * {μ}_{m , c 0} \qquad ( R4 )$$

Finally, we calculate a new membership degree μ_{ck} with cₖ=0 or 1 using all the satisfiability degrees of the m rules. For that, we may use a conorm ⊥ equal to the maximum between all the satisfiability degrees Fded_{m(c}_{ₖ}₎, namely:

$${μ}_{c 0} = {⊥}_{m = 1 , 2 , … , M} {Fded}_{m ( c 1 )} \qquad ( R5 )$$

$${μ}_{c 1} = {⊥}_{m = 1 , 2 , … , M} {Fded}_{m ( c 0 )} \qquad ( R6 )$$

As mentioned here above, the calculations are shown with a norm T and a conorm 1 which are respectively based on a minimum and a maximum. This is known as the approach of Zadeh. Nevertheless, other operators may be used for the norm and the conorm.

The following table gathers some possibilities.

TABLE 1

| Name | Norm [symbol] | Conorm ⊥ |
|---|---|---|
| Zadeh | min(x, y) | max(x, y) |
| Lukasiewicz | max(x + y − 1, 0) | min(x + y, 1) |
| Boole | xy | x + y − xy |
| Hamacher | xy/(x + y − xy) | (x + y − 2xy)/(1 − xy) |
| Einstein | xy/(2 − x − y − xy) | xy/(1 + xy) |

In an alternative method, we may also use a binary classification, which may be based on the classical Modus Ponem method. In this method, the fuzzy tree of FIG. 2 is used as a binary tree. Here, the similarity degree Deg(wₘ₍ⱼ₎,vₘ₍ⱼ₎) between the observed value wₘ₍ⱼ₎ and the break point vₘ₍ⱼ₎ of each attribute j of the rule m is calculated by a simple comparison, namely:

$$Deg ( {w}_{m ( j )} , {v}_{m ( j )} ) = sign ( {w}_{m ( j )} , {v}_{m ( j )} ) = \{ 0 , 1 \} \qquad ( R7 )$$

If sign(wₘ₍ⱼ₎,vₘ₍ⱼ₎)=1, namely μⱼ (wₘ₍ⱼ₎>μuⱼ(vₘ₍ⱼ₎) then, we can consider the next node of the tree, i.e. the next attribute (j+1) of the rule m, up to the leaf μ_{m,ck} with ck=0 or 1. If μ_{m,c1} is greater than μ_{m,c0}, then the class of the leaf is the value “1” (polyp). Otherwise, the class of the leaf is the value “0” (no polyp).

In order to construe additional similarity degrees, it is also possible to use a forest of fuzzy trees.

More precisely, step c) may be further based on at least one fuzzy forest comprising a plurality of fuzzy trees, as described here above. The outputs of each fuzzy tree, namely a classification according to either the first class or the second class, are subject to a conorm calculation in order to obtain a global classification according to either the first class or the second class.

A fuzzy forest is represented in FIG. 3.

The fuzzy forest uses n fuzzy trees in parallel, as represented in FIG. 3. We can then calculate a new degree of membership using a criterion with the degrees of membership of the n fuzzy trees with a conorm ⊥:

$${ϒ}_{0} = {⊥}_{i = 1 , … , n} \{ {μ}_{0} ( {Φ}_{i} ) \} \qquad ( R8 )$$

$$and :$$

$${ϒ}_{1} = {⊥}_{i = 1 , … , n} \{ {μ}_{1} ( {Φ}_{i} ) \} \qquad ( R9 )$$

The conorm may be one of those given in Table 1, in particular the conorm proposed by Zadeh. In this latter case, it means that if the similarity degree γ₁ of the class “1” is greater than the similarity degree γ₀ of the class “0”, the region of interest w is classified in the first class (polyp).

More information about the classification with fuzzy trees are for example available in Chuquimia & al., Polyps recognition using fuzzy trees, In 2017 IEEE EBMS International Conference on Biomedical Health Informatics (BHI) (February 2017), pp. 9-12.

The learning phase aims at constructing the fuzzy tree, and if any, the fuzzy forest by determining which attributes (Nodes of the tree) are the more important for polyp recognition. A learning phase that may be envisaged is for example available in Chuquimia & al., Polyps recognition using fuzzy trees, In 2017 IEEE EBMS International Conference on Biomedical Health Informatics (BHI) (February 2017), pp. 9-12. One important point for the learning phase are the available datasets. We may for example use the public database proposed by Tajbakhsh N. et al., Automated Polyp Detection in Colonoscopy Videos Using Shape and Context Information. IEEE Trans Med Imaging, 35, 2 (February 2016), pp. 630-644. (ASU-Mayo Clinic Colonoscopy Database). This database comprises 38 videos, 20 for learning (public) and 18 for test (not public). In this base, several spatial resolutions of images are provided. The main details are gathered in Table 2.

TABLE 2
(ASU-Mayo database)

| Film | Images | Résolution |
|---|---|---|
| 1 | 682(0) | 712 × 480 |
| 2 | 838(0) | 712 × 480 |
| 3 | 769(0) | 712 × 480 |
| 4 | 712(0) | 712 × 480 |
| 5 | 1843(0) | 712 × 480 |
| 6 | 1925(0) | 712 × 480 |
| 7 | 1550(0) | 712 × 480 |
| 8 | 1740(0) | 712 × 480 |
| 9 | 1802(0) | 712 × 480 |
| 10 | 1639(0) | 712 × 480 |
| 11 | 324(245) | 1920 × 1080 |
| 12 | 910(910) | 1920 × 1080 |
| 13 | 519(374) | 1920 × 1080 |
| 14 | 501(391) | 856 × 480 |
| 15 | 1200(1106) | 856 × 480 |
| 16 | 339(209) | 1920 × 1080 |
| 17 | 418(234) | 856 × 480 |
| 18 | 259(189) | 1920 × 1080 |
| 19 | 616(235) | 1920 × 1080 |
| 20 | 410(385) | 856 × 480 |

In order to improve this learning phase, the learning phase has however been improved within the frame of the disclosure.

According to a first step LP1), the fuzzy tree is constructed with a public database, for example the ASU-Mayo database.

Then, at a step LP2), a learning database of the regions of interests is constructed from the regions of interest automatically extracted from the classification step c) according to the disclosure.

Then, at a step LP3), the classification is tested on the public database, for example the ASU-Mayo database.

Thereafter, at a step LP4), the regions of interest that have not been correctly classified during the test carried out at step LP3) are put into the learning database of the regions of interest constructed at step LP2).

Finally, at a step LP5), the steps LP3) and LP4) are repeated as much as desired. In particular, these steps may be repeated up to obtain an expected accuracy.

At step d), the follow-up implies to estimate the movement of the region of interest (ROI) between two successive images of the video sequence.

One way to proceed is to use a mathematical technique called “block correspondence”.

In this technique, each region of interest (ROI) classified in the first class in said given image is represented as initially represented as d₁) a block of pixels B_{p,q} of size P*Q, where P and Q are natural integers.

Then, at step d₂), the block B_{p,q} is displaced according to several candidate movement vectors. More precisely, the block B_{p,q} is displaced from its initial position (p,q) towards the position (p-i, q-j) by a plurality of candidate movement vectors \vec{V}=(i,j).

At a step d₃), for each candidate movement vector, a comparison between a value of intensity associated with the block in said given image and the same value of intensity associated with the displaced block is carried out. More precisely, the vector In (B_{p,g}) of the values of intensity of the given image (considered as being the n^{th} image of the video-sequence) may be defined by the formulae:

$${I}_{n} ( {B}_{p , q} ) = {I}_{n ( p + 1 , q )} , … , {I}_{n ( p + P - 1 , q + Q - 1 )} \qquad ( R10 )$$

The estimate of the movement is done by determining a similarity between Iₙ (B_{p,q}) et Iₙ₊₁ (B_{p,q)} (n+1 referring to the image following said given image in the video sequence), for example by:

$${S}_{ij} = {\sum }_{p , q} \vert {I}_{n} ( {B}_{p , q} ) - {I}_{n + 1} ( {B}_{p - i , q - i} ) \vert \qquad ( R11 )$$

Then, at a step d₄) a candidate movement vector is considered as being the movement vector to be applied to the block where said comparisons, for example as expressed with Sᵢⱼ, is at a minimum value among the different candidate movement vectors.

Finally, in a step d₅), the block B_{p,q} is displaced from said given image to the following image in the video-sequence.

All the regions of interest classified as being in the first class in said given image (n^{th} image) will therefore be the regions of interest for the following image in the video sequence. Indeed, at the end of this step, we finally place a region of interest on a successive image issued from a region of interest classified in the first class for said given image at the end of step c).

At step e), the steps b) and c) are repeated for the regions of interest obtained at the end of step d) for the successive images. The main objective of this step is to verify that any region of interest classified in the first class at the end of step c) can still be considered as being in the first class on one or several successive images.

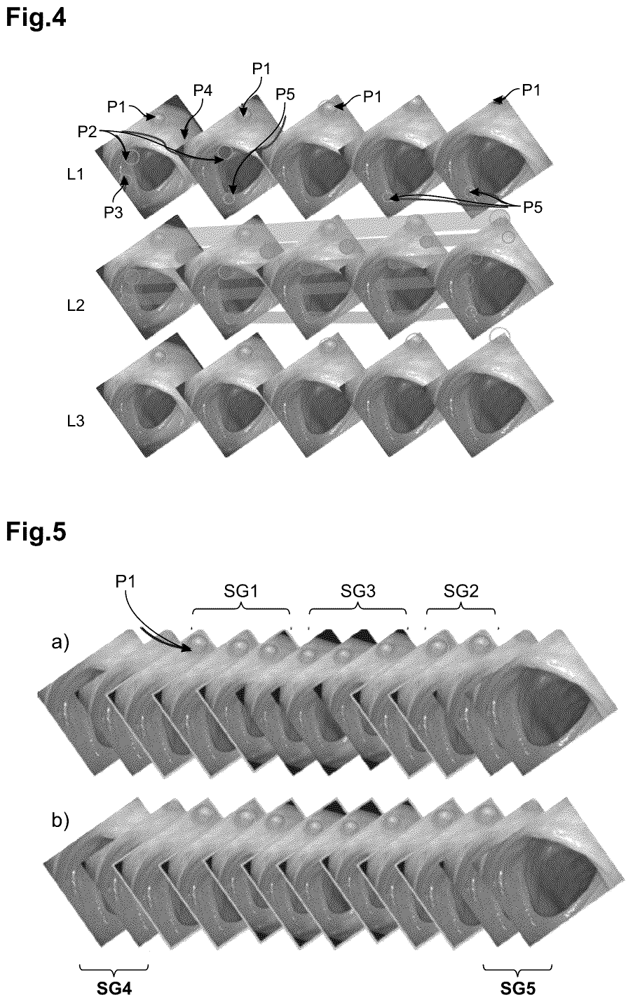

At the end of step f), we therefore obtain one or several regions of interest in the first class on successive images. It will be better understood with the example of FIG. 4.

FIG. 4 shows for a same video sequence, the effects of steps a) to f) of the method according to the disclosure. In this example, the video sequence comprises five successive images.

The first line (L1) of FIG. 4 shows the results of the method at the end of step c) (spatial analysis). In the first image, we can see four detected polyps P1, P2, P3, P4. In the second image, there are only three polyps, namely the polyps P1, P2 already detected in the first image and a new polyp P5 that had not been detected in the first image. The polyps P3 and P4 that had been detected in the first image are however not detected in the second image. In the third image, only the polyp P1 is detected. In the fourth image, only the polyp P5 is detected. And finally, in the fifth and last image, only the polyps P1 and P5 are detected.

The second line (L2) of the same video-sequence shows what the follow-up of step d) carries out. For example, any polyp P1, P2, P3, P4 detected in the first image is displaced by the motion technique described here above towards the second image. As a consequence, the polyp P3 that was not previously detected in the second image is now present in said second image. And the same polyp P3 is successively displaced on all the following images. A similar remark may be done for any polyp, for example the polyp P5 detected for the first time in the second image. Additionally, thanks to step d), the polyp P1 that was not detected in the fourth image is now present in this fourth image.

The third line (L3) of the same video sequence shows the effect of steps e) and f). At step e), each polyp is described and classified. For example, at the end of step f), the polyp P1 is considered as a true positive TP for all the images, namely for those where it had initially been detected (line 1, all the images except the fourth one) as well as for the image where it had not initially been detected (line 1, fourth image). In other words, the image for which the polyp P1 had not been initially detected (line 1, fourth image) is a false negative FN.

In FIG. 4, the video sequence comprises N=5 images which finally define the temporal depth of the follow-up. It should however be noted that a temporal depth of N=3 may be sufficient to obtain substantial improvements.

Step g) is carried out after step f) so that it takes into consideration the effects and results of step f).

FIG. 5 shows for a same video sequence the effects of step g). The video sequence shown in FIG. 5 is however different from the video sequence of FIG. 4. More precisely, in this example the video sequence of FIG. 5 (first line) comprises twelve images, in which we can distinguish two sub-groups SG1, SG2 where a polyp was detected at the end of step f) (first aggregation: aggregation of regions of interest), accordingly obtained from two sub-sequences to the video-sequence of FIG. 5. Between these two sub-groups, we can see a third sub-group SG3 where the polyp P1 has not been detected. The action of step g) (second aggregation: aggregation of images) can be seen in the second line of FIG. 5. The polyp P1 appears for the first time in the third image and for the last time in the tenth image. As a consequence, the aggregation maintains the region of interest associated with this polyp P1 also in the images of the third sub-group SG3 (sixth, seventh and eighth images of the video-sequence). At the end of step g), the images of the sub-group SG3 are then considered as false negatives FN. At the same time, The images of the sub-groups SG4 and SG5 where no polyp was detected are confirmed as being true negatives TN.

The polyp is therefore finally detected.

It is also possible to calculate some parameters allowing to quantitatively estimate the performance of the method according to the disclosure with the following parameters:

$$SE ( \% ) = \frac{T P}{T P + F N} * 100 \% \qquad ( R12 )$$

$$and :$$

$$SP ( \% ) = \frac{T N}{T N + F P} * 100 \% \qquad ( R13 )$$

where:
SE is called the sensitivity (or sometimes “recall”),
SP is called the specificity, and as earlier mentioned:
TP: True Positive
FN: False Negative
TN: True Negative, and
FP: False Positive.

A test has been carried out to estimate the performances of the method according to the disclosure.

The conditions of this test are the followings: Step a) implements all the sub-steps a₀) to a₄). The sub-step a₀) uses the relationship (R1). The sub-step a₁) uses a median filter of size 3*3. The sub-step a₂) uses a Canny filter and finally the sub-step a₃) uses a Hough transform. Step b) uses the 26 descriptors mentioned in the ANNEX. Step c) uses a fuzzy tree and a fuzzy forest with all the criteria expressed in the relationships (R2) to (R9) (generalized Modus Ponem). Zadeh is used for the norm and the conorm. Step d) uses the “block correspondence” method and therefore implements all the sub-steps d₁) to d₄) explained previously. For Step e), the same 26 descriptors of step b), and the same fuzzy forest (with the same fuzzy trees) of step c) are used. Finally, it is specified that the learning phase for each fuzzy tree and the fuzzy forest implements the sub-steps LP1) to LP5) with the ASU-Mayo database. After step e), namely after the step of follow-up of the regions of interest, the sensitivity and the specificity were respectively estimated at SE=79% and SP=65%.

Then, the two steps of aggregation, namely the first aggregation and the second aggregation, were implemented with, respectively, a temporal depth of 3 images and 10 images.

At the end of these last steps, the sensitivity and the specificity were respectively increased up to SE=90% and SP=75%.

In other words, the performance have shown to be clearly improved.

The disclosure also concerns a device comprising a means for acquiring a video sequence, and a processor or a plurality of processors to carry out, from said video sequence, the method according to the disclosure. The means for acquiring a video sequence is typically a camera or a set cameras. The device advantageously also comprises a memory to save the video sequences.

In particular, the device may be an endoscopic capsule, for example the endoscopic capsule proposed in WO2019/122338 A1.

In an alternative, the device may be affixed or integrated to an endoscope, for example the endoscope proposed in US 2022/0094901 A1.

### ANNEX

The descriptors f1 to f4 here below are luminosity descriptors calculated from the histogram H (i) of luminosity, with i=1, . . . , 255.
1. Mean value

$${f}_{1} = μ = {\sum }_{i = 0}^{255} iH ( i ) \qquad ( A \text{.1} )$$

2. Variance

$${f}_{3} = {σ}^{- 3} = {\sum }_{i = 0}^{255} {( i - μ )}^{3} H ( i ) \qquad ( A \text{.3} )$$

3. Skewness

$${f}_{4} = {σ}^{- 4} = {\sum }_{i = 0}^{255} {( i - μ )}^{4} H ( i ) \qquad ( A \text{.4} )$$

4. Curtosis

$${f}_{5} = {\sum }_{i = 0}^{255} {\sum }_{j = 0}^{255} ijM ( i , j ) \qquad ( A \text{.5} )$$

The descriptors f5 to f26 are texture descriptors than can be calculated from the co-occurrence matrices M (i,j), with i=1, . . . , 255 and j=1, . . . , 255.
5. Autocorrelation

$${f}_{2} = {σ}^{2} = {\sum }_{i = 0}^{255} {( i - μ )}^{2} H ( i ) \qquad ( A \text{.2} )$$

6. Contrast

$${f}_{6} = {\sum }_{i = 0}^{255} {\sum }_{j = 0}^{255} {( i - j )}^{2} M ( i , j ) \qquad ( A \text{.6} )$$

7. Special Correlation (together with A.8 to A.11)

$${f}_{7} = {\sum }_{i = 0}^{255} {\sum }_{j = 0}^{255} \frac{ijM ( i , j ) - {μ}_{x} {μ}_{y}}{{σ}_{x} {σ}_{y}} \qquad ( A \text{.7} )$$

where:

$${μ}_{x} = {\sum }_{i = 0}^{255} {\sum }_{j = 0}^{255} iM ( i , j ) \qquad ( A \text{.8} )$$

$${μ}_{y} = {\sum }_{i = 0}^{255} {\sum }_{j = 0}^{255} jM ( i , j ) \qquad ( A \text{.9} )$$

$${σ}_{x} = {\sum }_{i = 0}^{255} {\sum }_{j = 0}^{255} {( i - {μ}_{x} )}^{2} M ( i , j ) \qquad ( A \text{.10} )$$

$${σ}_{y} = {\sum }_{i = 0}^{255} {\sum }_{j = 0}^{255} {( j - {μ}_{y} )}^{2} M ( i , j ) \qquad ( A \text{.11} )$$

8. Correlation of Chiolero & al.

$${f}_{8} = {\sum }_{i = 0}^{255} {\sum }_{j = 0}^{255} \frac{( i - {μ}_{x} ) ( j - {μ}_{y} ) M ( i , j )}{{σ}_{x} {σ}_{y}} \qquad ( A \text{.12} )$$

9. Dissimilarity

$${f}_{9} = {\sum }_{i = 0}^{255} {\sum }_{j = 0}^{255} \vert i - j \vert M ( i , j ) \qquad ( A \text{.13} )$$

10. Cluster Shade

$${f}_{10} = {\sum }_{i = 0}^{255} {\sum }_{j = 0}^{255} {( i + j - {μ}_{x} - {μ}_{y} )}^{3} M ( i , j ) \qquad ( A \text{.14} )$$

11. Cluster Proeminence

$${f}_{11} = {\sum }_{i = 0}^{255} {\sum }_{j = 0}^{255} {( i + j - {μ}_{x} - {μ}_{y} )}^{4} M ( i , j ) \qquad ( A \text{.15} )$$

12. Energy Matlab

$${f}_{12} = {\sum }_{i = 0}^{255} {\sum }_{j = 0}^{255} {M ( i , j )}^{2} \qquad ( A \text{.16} )$$

13. Entropy

$${f}_{13} = {\sum }_{i = 0}^{255} {\sum }_{j = 0}^{255} M ( i , j ) {log}_{2} M ( i , j ) \qquad ( A \text{.17} )$$

14. Maximal Probability

$${f}_{14} = {Max}_{i , j} ( M ( i , j ) ) \qquad ( A \text{.18} )$$

15. Homogeneity

$${f}_{15} = {\sum }_{i = 0}^{255} {\sum }_{j = 0}^{255} \frac{M ( i , j )}{1 + \vert i - j \vert} \qquad ( A \text{.19} )$$

16. Inverse Difference Moment (IDM)

$${f}_{16} = {\sum }_{i = 0}^{255} {\sum }_{j = 0}^{255} \frac{M ( i , j )}{1 + {( i - j )}^{2}} \qquad ( A \text{.20} )$$

17. Variance

$${f}_{17} = {\sum }_{i = 0}^{2 x 255} {( i - μ )}^{2} M ( i , j ) \qquad ( A \text{.21} )$$

18. Sum of mean values

$${f}_{18} = {\sum }_{i = 0}^{2 x 255} {iM}_{x + y} ( i ) \qquad ( A \text{.22} )$$

$$with :$$

$${M}_{x + y} ( k ) = \frac{{\sum }_{i = 0}^{255} {\sum }_{j = 0}^{255}}{\vert i + j \vert = k} M ( i , j ) k = 0 , 2 , 3 , … , 2 x 255 \qquad ( A \text{.23} )$$

19. Sum of Variances

$${f}_{19} = {\sum }_{i = 0}^{2 x 255} {( i - {f}_{18} )}^{2} {M}_{x + y} ( i ) \qquad ( A \text{.24} )$$

20. Sum of entropies

$${f}_{20} = {\sum }_{i = 0}^{255} {M}_{x + y} log {M}_{x + y} \qquad ( A \text{.25} )$$

21. Difference of Variances

$${f}_{21} = {\sum }_{i = 0}^{255} {( i - {μ}_{{M}_{x - y}} )}^{2} {M}_{x - y} ( i ) \qquad ( A \text{.26} )$$

$$where :$$

$${M}_{x - y} ( k ) = \frac{{\sum }_{i = 0}^{255} {\sum }_{j = 0}^{255}}{\vert i - j \vert = k} M ( i , j ) k = 0 , 2 , 3 , … , 255 - 1 \qquad ( A \text{.27} )$$

$${μ}_{{M}_{x - y}} = {\sum }_{i = 0}^{255} {iM}_{x - y} ( i ) \qquad ( A \text{.28} )$$

22. Difference of Entropies

$${f}_{22} = {\sum }_{i = 0}^{255} {M}_{x - y} log {M}_{x - y} \qquad ( A \text{.29} )$$

23. and 24. Correlation measurements Information

$${f}_{23} = \frac{MXY - MXY 1}{max ( MX , MY )} \qquad ( A \text{.30} )$$

$${f}_{24} = {( 1 - esp ( - 2 ( MXY 2 - MXY ) ) )}^{\frac{1}{2}} \qquad ( A \text{.31} )$$

$$with :$$

$${M}_{x} ( i ) = {\sum }_{j = 0}^{255} M ( i , j ) \qquad ( A \text{.32} )$$

$${M}_{y} ( i ) = {\sum }_{i = 0}^{255} M ( i , j ) \qquad ( A \text{.33} )$$

$$MX = - {\sum }_{i = 0}^{255} {M}_{x} ( i ) log {M}_{x} ( i ) \qquad ( A \text{.34} )$$

$$MY = - {\sum }_{i = 0}^{255} {M}_{y} ( i ) log {M}_{y} ( j ) \qquad ( A \text{.35} )$$

$$MXY = - {\sum }_{i = 0}^{255} {\sum }_{j = 0}^{255} M ( i , j ) log M ( i , j ) \qquad ( A \text{.36} )$$

$$MXY 1 = - {\sum }_{i = 0}^{255} {\sum }_{j = 0}^{255} M ( i , j ) log {M}_{x} ( i ) {M}_{y} ( j ) \qquad ( A \text{.37} )$$

$$MXY 2 = - {\sum }_{i = 0}^{255} {\sum }_{j = 0}^{255} {M}_{x} ( i ) {M}_{y} ( j ) log {M}_{x} ( i ) {M}_{y} ( j ) \qquad ( A \text{.38} )$$

25. Moment Inverse Difference

$${f}_{25} = {\sum }_{i = 0}^{255} {\sum }_{j = 0}^{255} \frac{M ( i , j )}{1 + {( i - j )}^{2}} \qquad ( A \text{.39} ) \vert$$

26. Normalized Inverse Difference

$${\sum }_{i = 0}^{255} {\sum }_{j = 0}^{255} \frac{M ( i , j )}{1 + ( \frac{{\vert i - j \vert}^{2}}{{N}_{g}^{2}} )} \qquad ( A \text{.40} )$$

with N_{g} representing the total number of different pixel intensity values.

1. A method for detecting polyps from a video sequence comprising a plurality of images, said method comprising the following steps:
a) an extraction of regions of interest (ROI) likely to contain a polyp, said extraction consisting of determining circular or elliptical shapes within said images;
b) a description of said regions of interest with at least one predefined descriptor, advantageously with at least one texture descriptor and at least one luminance descriptor;
c) a classification of said regions of interest according to the following rules:
if said region of interest is considered as containing a polyp by means of said at least one descriptor, it is classified in a first class,
if said region of interest is considered as not containing any polyp, by means of said at least one descriptor, it is classified in a second class;
d) a follow-up, by a motion estimation technique, of any region of interest belonging to the first class from a given image and on successive images following said given image;
e) for each of said successive images, a repetition of step b) and of step c) for said regions of interests that are subject of the follow-up; and
characterized in that said method further comprises the following steps:
f) an aggregation of same regions of interest on said images called first aggregation, said first aggregation consisting of maintaining as a region of interest belonging to the first class on a given image, a region of interest also classified in the first class for each successive images; and then:
g) an aggregation of images called second aggregation, said second aggregation consisting of maintaining as a region of interest on any image comprised between a first image and a second image, a region of interest appearing for the first time on said first image and for the last time on said second image.

2. The method according to claim 1, wherein step a) comprises, for any image in color, the following sub-steps:
a₀) converting said given image in shades of grey;
a₁) noise filtering the image, for example with a 3*3 median filter;
a₂) identifying shapes in the image, for example with a Canny filter;
a₃) identifying circular or elliptic shapes among the shapes previously identified within said image; and
a₄) extracting a region of interest (ROI) from any region of said image whereby a circular or elliptical shapes has been identified.

3. The method according to claim 1, wherein several predefined descriptors are chosen for step b) among which descriptors related to both the texture and the luminosity.

4. The method according to claim 1, wherein step c) is based on at least one fuzzy tree comprising at least one attribute and a plurality of classes, said at least one attribute corresponding to said at least one descriptor and said plurality of classes comprising the first class and the second classes.

5. The method according to the claim 4, wherein said at least one fuzzy tree is a fuzzy tree is constructed by means of a learning phase comprising the following steps:
LP1) constructing said at least one fuzzy tree with a public database, for example the ASU-Mayo database;
LP2) constructing a learning database of the regions of interests from the regions of interest automatically extracted from the classification of step c);
LP3) testing said classification on said public database;
LP4) putting into the learning database of the regions of interest constructed at step LP2), the regions of interest that have not been correctly classified during the test carried out at step LP3); and
LP5), repeating steps LP3) and LP4), for example for a predefined number of iterations.

6. The method according to claim 4, wherein step c) is further based on at least one fuzzy forest comprising a plurality of fuzzy trees according to the preceding claim and whose outputs, namely the classification according to either the first class or the second class, are subject to a conorm calculation in order to obtain a global classification according to either the first class or the second class.

7. The method according to claim 1, wherein
step d) is carried out by a block corresponding method comprising the following sub-steps:
d₁) associating a region of interest belonging to the first class in said given image with a block of P*Q pixels*pixels, where P, Q are natural integers;
d₂) displacing said block B_{p,q} according to several candidate movement vectors;
d₃) carrying out, for each candidate movement vector, a comparison between a value of intensity associated with the block in said given image and the same value of intensity associated with the displaced block;
d₄) determining the candidate movement vector for which the comparison reaches a minimum value; said candidate movement vector being therefore the movement vector with which the bloc B_{p,q} has to be displaced; and
d₅) displacing the block from said given image to said successive images with according to said movement vector.

8. The method according to claim 1, wherein step e) as well as step f) are carried out with a temporal depth equal or greater than 3 images.

9. The method according to claim 1, wherein step g) is carried out with a temporal depth equal or greater than 10 images.

10. A device comprising:
a means for acquiring a video sequence, and
a processor or a plurality of processors to carry out, from said video sequence, the method according to one of the preceding claims.

11. A device according to the claim 10, wherein said device is an endoscopic capsule.

12. A device according to claim 11, wherein said device is affixed or integrated in an endoscope.
